(19) United States
(12) Patent Application Publication
(10) Pub. No.: US 2004/0204979 A1
(43) Pub. Date: Oct. 14, 2004

(54) Persuasive website design system and method

(76) Inventors: Jeffrey Eisenberg, Brooklyn, NY (US); Bryan Eisenberg, Brooklyn, NY (US); John C. Quarto-vonTivadar, Brooklyn, NY (US)

Correspondence Address: FULBRIGHT & JAWORSKI L.L.P., SUITE 2400, 600 CONGRESS AVENUE, AUSTIN, TX, 78701-3271, US

(21) Appl. No.: 10/394,514

(22) Filed: Mar. 21, 2003

(51) Int. Cl. G06F 17/60

(52) U.S. Cl. 705/10; 705/26

(57) ABSTRACT

Systems and methods are described for creating and using a persuasive web site usable in electronic business applications. The invention includes defining a plurality of personae of prospective customers anticipated to access a web site, creating a plurality of web pages as a function of the defined personae, creating a plurality of paths connecting the web pages as a function of the defined personae, storing the plurality of web pages and data regarding the plurality of paths, and providing access to the plurality of web pages to prospective customers according to the plurality of paths as a function of a persona of each prospective customer.

### BACKGROUND OF THE INVENTION

1. Field of the Invention

The invention relates generally to the field of electronic commerce and electronic business.

2. Discussion of the Related Art

The commerce of products and services via computers is becoming a large part of the global economy. Yet, as large as sales figures may seem, they are only a small fraction of the potential in each segment. Retail sales on the Internet still represent approximately less than 0.5% of all retail sales in the United States, arguably the most wired and Internet savvy market in the world.

Commercial websites continue to suffer from low conversion rates and a low return on investment. Seven out of every ten commercial development projects fail, and those that do achieve completion typically incur eighty percent of their total costs after they have gone live. Once in operation, a typical website experiences only a 2-5% conversion rate on tens of thousands of potential customers.

Traditionally, web development has largely been managed by technical specialists who lack an understanding of the business imperatives and a business-centered methodology. Further, there has been a persistent misunderstanding of the nature of the medium that has influenced the image of the commercial website as merely a software tool, largely by the business specialists, who therein cede their responsibility for business-centered principles to the technical staff.

Thus, there is a need for an electronic business system and method to improve the online sales experience and increase conversion rates.

### SUMMARY OF THE INVENTION

There is a need for the following embodiments. Of course, the invention is not limited to these embodiments.

In accordance with one exemplary embodiment of the invention, a computer system is provided for electronic commerce or electronic business services, the computer system comprising, a network, a customer computer associated with a customer and connected to the network and including a web browser for accessing and communicating over the network and a merchant computer associated with a merchant and connected to the network, the merchant computer being accessible by the customer computer via the network, the merchant computer including a plurality of web pages constructed and configured according to predetermined personae of customers anticipated to access the merchant computer.

In accordance with another aspect of the invention, a method for electronic business includes, defining a plurality of personae of customers anticipated to access an electronic business web site, creating a plurality of web pages as a function of the defined personae, creating a plurality of paths connecting the web pages as a function of the defined personae, storing the plurality of web pages and data regarding the plurality of paths, and providing access to the plurality of web pages to prospective customers according to the plurality of paths as a function of a persona of each prospective customer. The prospective customers navigate through the plurality of web pages according to one of the paths corresponding to the personae of the prospective customer.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein like reference numerals (if they occur in more than one view) designate the same or similar elements. The invention may be better understood by reference to one or more of these drawings in combination with the description presented herein. It should be noted that the features illustrated in the drawings are not necessarily drawn to scale.

FIG. 1 is a block diagram of an e-commerce system, representing an embodiment of the invention.

FIG. 2 is a flowchart of an e-commerce site creation method, representing an embodiment of the invention.

FIG. 3 is a flowchart of a wireframing method, representing an embodiment of the invention.

FIG. 4 is a diagram of an electronic business web site, illustrating aspects of the invention.

FIGS. 5A-5D are screenshots of selected screens taken from the electronic business site of FIG. 4, illustrating aspects of the invention.

### DETAILED DESCRIPTION

The invention and the various features and advantageous details thereof are explained more fully with reference to the nonlimiting embodiments that are illustrated in the accompanying drawings and detailed in the following description. It should be understood that the detailed description and the specific examples, while indicating specific embodiments of the invention, are given by way of illustration only and not by way of limitation. Various substitutions, modifications, additions and/or rearrangements within the spirit and/or scope of the underlying inventive concept will become apparent to those of ordinary skill in the art from this disclosure.

The invention may include an electronic business (e-business) system such as, for example, an electronic commerce (e-commerce) internet site, a self-service site, a lead generation site, and/or a content site. The invention may also include an e-business internet site which utilizes business centered methods to improve the online sales experience and increase conversion rates.

In one embodiment, the invention may be a computer-based method and system that may reside, for example, as a web site on the Internet or on a CD-ROM software package.

The invention may include defining one or more different personae and utilizing an e-commerce system to implement distinct sales approaches for different customers based on the distinct personae. Personae may be described as models which define specific characteristics of customers as well as actions they take. In one exemplary embodiment, a fully implemented persona is based on a tripod model.

The first leg of the persona creation tripod model is demographics, which is defined herein to include for various statistical information about site visitors, such as age group, gender, and median income. This numbers-only approach generally produces simple measurement summaries describing what the persona “is”. An example of demographics is: “Fred is the CFO of his widget-producing company, with sales in excess of US $20 M per year. He's 41 years old, married with 3 children, and has been a customer of ours for 11 years, including his previous job as Comptroller at a competing widget firm. Fred is looking for ways to reduce his company's significant costs of printing and distributing updated product manuals each year, and sees our company's new Wizard technology as a potential way to add $500,000 to his bottom line.” Generally, this is an example of the extent of research provided by marketing departments, and does not include two other aspects (or legs) of the persona creation tripod which describe what the persona “does” (i.e.:, “how the persona acts”). In order to describe persona actions, it may be recognized that model archetypes of human behavior should enhance differences instead of averaging them out. In practice, an actual customer may be a blend of these orthogonal archetypes.

The second leg in the persona creation tripod is psychographics, which is defined herein to include the creation of descriptions of what each persona does in their approach to making a purchase. An example of psychographics is: “Fred places a high priority on relationship and past experience with a vendor, preferring to stick to the comfortable and the known, and looking for guarantees that decisions will not be risky. He wants to feel that the vendor is committed to him because of his long-standing status as a regular customer.” The sales approach to be taken by the e-business system of the present invention may be quite different for Fred than for another CFO at another firm who may be looking at exactly the same product line, but who wants the best price and follows a disciplined, methodical approach to getting the best price possible.

The third leg of the persona tripod is topographies, which is defined herein as the criteria and factors which may influence a persona's decision for this particular product, service, or industry, given their demographic and psychographic profile. In other words, it includes a study of the obstacles to purchase which may exist and corresponding solutions intended to minimize these obstacles.

With these three legs of the persona tripod in place, there is an extensive understanding of the handful of archetypical personas who describe the full spectra of actual customers to visit the e-business system of the present invention. Further, each persona may be matched to a scenario for maximum persuasive impact.

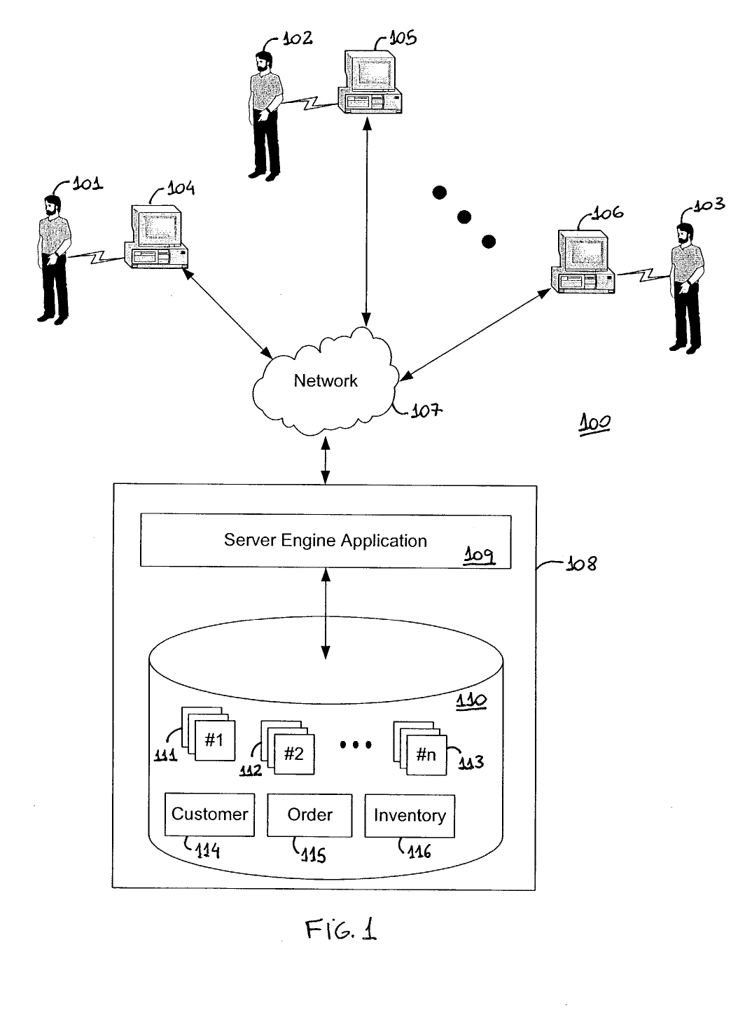

Referring to FIG. 1, a block diagram of an electronic business system 100 is depicted according to an exemplary embodiment of the invention. A merchant site 108 hosted by a merchant computer (not shown) and a plurality of customer computers 104-106 may interact by exchanging information via a network 107, which may include, for example, the internet, a wide area network (WAN) or a local area network (LAN). Each customer computer 104-106 may be accessible by a customer 101-103 and may contain a browser. The merchant site 108 includes a server engine 109 and a main database 110. The main database 110 may include a plurality of sets of web pages 111-113, a customer database 114, an order database 115, and an inventory database 106.

In one embodiment, when the network 107 is the world wide web (WWW), the server engine 109 receives a hypertext transfer protocol (HTTP) request to access a web page identified by a uniform resource locator (URL) and provides the web page to the requesting browser hosted in a customer computer 104-106. Further, the server engine 109 also has access to the customer database 114, the order database 115, and the inventory database 106, all of which may be used to present information to customers 101-103. The customer database 114 may include data about returning or registered customers. The order database 115 may contain entries for each order that has been received from customers along with information regarding the shipping status of the orders. The inventory database 116 may contain a description of the various items that may be ordered. Other features and functions may also be included in merchant site 108, including, for example, a search engine for searching databases 106, 114 and 115

In one embodiment, the server engine 109 may classify customers 101-103 operating computers 104-106 according to predetermined personae established in accordance with the present invention, and provide the corresponding computers 104-106 with one or more web pages associated with these predetermined personae. The sets of web pages 111-113 may contain information tailored to each predetermined persona, presenting the inventory 116 so as to improve the customer's online sales experience and meet a business goal, such as increasing conversion rates. Although depicted as separate sets in FIG. 1, web pages 111-113 may in fact intersect and may share common web pages. For example, during the creation of web pages 111-113, the use of the predetermined personae may result in different customers being directed to the same web page as the different customers, corresponding to the different personae, navigate the web site through different but intersecting paths. This will be explained in more detail below.

As one of ordinary skill in the art will recognize in light of this disclosure, the server engine 109 may identify a customer's persona by their response to a question, or a set of questions built in to one or more web pages. The server engine 109 may also identify a customer's persona by monitoring an action, such as a mouse click, data entry, or the like.

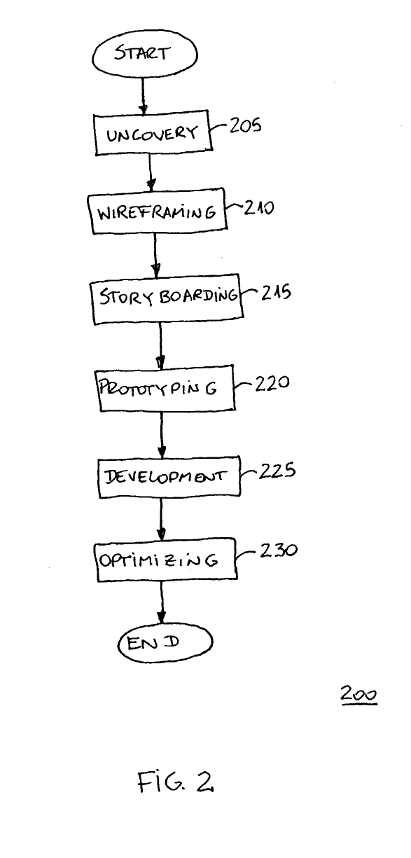

Referring to FIG. 2, a flowchart of an e-business site creation method 200 is depicted according to an exemplary embodiment of the invention. Method 200 may be used, for example, to implement an e-business site, such as site 108 shown in FIG. 1.

An uncovery step 205 includes identifying the value of a business and articulating it to a customer. In one embodiment, a model, such as a Johari Window, may be used for this purpose. A Johari Window describes the relationships of known and unknown information in human interaction, including business-customer. Table I below represents a Johari Window useable in the present invention.

TABLE I

| | Known to Business | Unknown to Business |
|---|---|---|
| Known to Customer | OPEN | BLIND |
| Unknown to Customer | HIDDEN | UNKNOWN |

In the Johari Window of Table I, a four-paned “window” divides personal awareness into four types, or quadrants: open, unknown, blind, and hidden. The lines dividing the four panes move as an interaction progresses to reflect the changes in the relationship.

The open quadrant represents information mutually known between a business and a customer. The knowledge this window represents can include not only factual information but also feelings, motives, behaviors, wants, needs, and desires or any other information describing who the business or customer is. The unknown quadrant represents information that is mutually unknown. In this realm, true discovery is possible. While it is not impossible to discover something neither the business nor its customers know about the exchange, it is very unlikely. The blind quadrant represents information not known to the business, but known to customers. This is the phase in uncovery in which a business identifies what is known to the customer that must be revealed to the business. The hidden quadrant represents information a business knows about itself but a customer does not know. This hidden information may be the key to a great uncovery. The findings in the blind quadrant may trigger some flow of information that initially was in the hidden quadrant.

Uncovery 205 may also include, for example, mapping of objectives. Typically, objectives may set forth bow to measure success. A proper objective may be quantifiable: for example, 200 qualified leads in the next 30 days or gross product sales of $15 million in the next quarter. Once defined, objectives may be broken down into their component parts and prioritized. Strategic recommendations may also be developed.

Further, uncovery 205 may also include development of personae. Understanding the different user cases (profiles of the different personalities of customers) that comprise potential target market allows a business to create profiles based on personality types. This, in turn, makes it possible to construct a buying and selling process that appeals to the variety of needs visitors may have so customers can feel comfortable in buying. Generally, customers should be presented with something they want or need, together with the right value proposition. In other words, to make the right presentation to various prospects, a business may “qualify” their level of interest, their motivation, their timeframe, their financial situation, and whether the product or service (as presented) meets their needs.

A commercial site may get four types of traffic: perfect prospective customers who know exactly what they want, prospects who sort of know what they want but have not yet narrowed down their search criteria, prospects who aren't sure they want anything but might buy if what they want were to appear, and a fourth group of visitors who aren't prospects, nor are they qualified to take advantage of the product or service. During uncovery 205 and the subsequent wireframing step 210, it is possible to distinguish between scenarios of the buying process of visitors to the site and therefore how each visitor can be matched to an appropriate sales process that meets their goals, desires and needs. This illustrates how, for example, a 42-year-old divorced mother of three, a 54-year-old male CEO, and a shy 26-year-old male programmer might buy. From page to page on an e-business site, each may take different actions for different reasons and motivations. Even when each is successfully persuaded to buy, there were three unique buying experiences.

Uncovery 205 may also include understanding a customer's buying process. The objective is to understand and address how customers approach the general process of making a buying decision in the field under consideration. It is known that, whenever customers make a buying decision, that decision represents the culmination of a process. It may take place almost instantaneously or stretch out over a long period of time, but it is a process, not an event. No matter how long the process takes, the buying decision always begins when customers become aware of a need. Once customers have identified that need, they begin to search for and explore possible avenues for meeting it. While gathering information, they refine and evaluate all the buying criteria that will affect the decision to purchase and narrow the field of choice to the “best few” alternatives. Once they reach a decision and choose, they take action by making a purchase. The final step in the process involves a reevaluation of the decision and its results. The persuasion architecture of the entire e-business site may recognize every step of the consumer buying process. Each step feeds and leads to the others. Although the process ultimately is linear, there can be feedback loops within the process as the customer re-evaluates information. Hence, two, three, or even all five steps may be addressed on a single page.

Further, uncovery 205 may include understanding and refining the sales process. A sales process may include five steps: prospect, rapport, qualify, present, and close. The process may not be strictly linear. Rapport, qualify and present are iterative; each step feeds and influences the others as the overall process moves toward the close. Selling is a process of evaluation and reevaluation for both the business and the prospective customer. It is a goal of uncovery 205 to clearly identify and map out the sales process and the different paths customers can take to move to and beyond the close.

Finally, uncovery 205 may also include, for example, definition of key business metrics. A business may create a comprehensive answer to the question of how to measure success, or how successfully its e-business site persuades prospective customers visiting the site to take the desired actions.

A wireframing step 210 includes creating a skeletal rendering of possible click-throughs on the e-business site, such as a text-only action, decision, or experience model. Wireframing 210 maintains the flow of logical and business functions by identifying all the entrance and exit points on each of the pages of the site. The development of wireframing 210 may be guided by definition of personae, actions, and what information is needed for a particular persona to execute a particular action.

The wireframing step 210 focuses on what the business wants its e-business site to do, not necessarily on how it should be done. The development of a wireframe may be guided by what personae (types of visitors) need to be persuaded, what actions they need to take, and what information they require to take such action. These questions may help map out the most effective and complimentary buying and selling processes, and allow creation of scenarios that meet the differing needs of the personae defined during the uncovery step 205. Further, what emerges through the wireframe is a form of decision tree, with different branches representing different outcomes, based on how customers may move through the site (primary trajectories, secondary, etc.). With these elements, prospects may be propelled through the site via the decision-making reasoning they are most comfortable with. In one embodiment, the wireframe is an enhanced flowchart without graphical images that demonstrates every click-through possibility on the site.

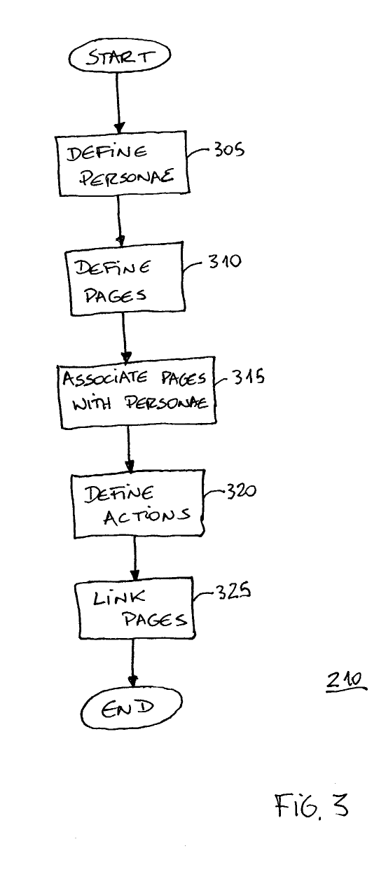

If more than one type of visitor uses the site, then the wireframe step 210 examines each of these user cases to ensure that persuasion architecture will move them along towards conversion. Wireframing 210 also addresses how multiple personae interact with a given page in non-linear scenario-based ways. Wireframing 210 may define and limit what actions can be taken from any one page, avoiding paralysis of analysis by overwhelming the visitor with too many choices, some of which may not be necessary at that point. Also, the process ensures each page has a clear call to action that motivates the visitor to go forward and leads specifically to the creation of content, such as copy or imaging, that supports such calls to action. Further, the wireframing step 210 presents a process for business-centric decisions to be molded into the foundation of the project so that any evolution from this point continues to reflect these decisions. The wireframing step 210 is further depicted in FIG. 3.

A storyboarding step 215 includes developing potential design schemes that support the flow of actions defined in the wireframing step 210. The result of storyboarding 215 may look like an enhanced flow chart, with visual representations of each web page. Each representation may describe the web page and contain a summary of copy and content, layout, graphics, and responsibilities. For example, responsibilities of every page include motivating visitors to continue taking action and making it easy for them to do so, as defined in the wireframing step 210. Once mockups are completed, images may be turned into an HTML document. Other considerations at this stage include download time, compatibility with multiple browsers, use of cascading style sheets for simplicity, laying out of tables with an understanding of how search engines spider a web site, and choosing fonts with an eye toward easy screen reading.

A prototyping step 220 includes development of an operational model of the e-commerce site. A prototype is a full model of the final site to be built that is in accurate in virtually all aspects with the possible exception of scale and persistence of live data. The prototyping step 220 may include creating complete scenarios and performing acceptance tests. In one embodiment, the site evolves towards a frozen prototype using comments by all participants in the site creation that may be managed on a screenshot-by-screenshot basis. Once the final prototype is complete, decision-makers who have a say in the end product sign-off on the prototype, freezing the format and defining that what the prototype looks like and does at the point is how the final delivered product should look and act.

A development step 225 includes delivery of a finished e-business site. After the prototyping step 220 has been successfully completed, the e-business site may be programmed or coded. Because all of the guess-work has been removed, development may be quick and precise.

Finally, an optimizing step 230 includes critical evaluation and improvement of results achieved by the e-commerce site. In the optimization step 230, a number of known business metrics, such as, but not limited to, those outlined in Eisenberg and Novo, “The Marketer's Common Sense Guide to eMetrics” (published 2002), the disclosure of which is expressly incorporated herein by reference, may be used for making decisions, including, for example, content metrics and commerce metrics (such as conversion rates and the like.) Additionally, when content metrics and commerce metrics are analyzed via scenario reports that mimic the personae scenarios outlined during uncovery and wireframing, the entire process of optimization then becomes iterative towards continual improvement and accountable towards precise correlation between Optimization cause and Return-on-Investment effect. From analysis of these metrics, changes to the e-business site may be made individually so that the results may be tracked effectively.

Referring to FIG. 3, a flowchart of a wireframing method 210 is depicted according to an exemplary embodiment of the invention. In step 305, the personae proposed during the uncovery step 205 (detailed in FIG. 2) are defined. In this step, a persona name, a persona description, and a persona symbol (such as an identifier or a color) may be associated with each persona. In one embodiment, each persona description includes demographic information, psychographic information, and/or topographic information. The demographic information may include, for example, age, gender, income, or the like. The psychographic information may include a description of how the persona makes a purchase or is otherwise successfully persuades to take action. The topographic information may include a description of what criteria and factors my influence the persona's decision to purchase a particular product or service or to otherwise be successfully persuaded to take the action that the business whishes them to take at that point.

The wireframing method 210 provides a chance to look for process flow of each personae identified during the uncovery step 205. By examining how the site flows for the various users on the site, a business may identify key points where users may have questions that may be addressed to help guide them. The method 210 also allows a business to define the motivation behind every page and the function of each page.

In step 310, the web pages proposed during the uncovery step 205 are defined. In this step, a page name, a page function, and a page responsibility/comments may be associated with each web page. In step 315, each web page is associated with a persona. In step 320, actions are defined in order to create entrance points to, and exit points from, every page page. In step 325, the actions are used to link a group or set of pages.

The wireframing method 210 may be repeated until a number of personas and a number of sets of pages, each associated with a persona, have been defined. Method 210 allows an e-business site architecture to move different types of customers (personae) along towards conversion.

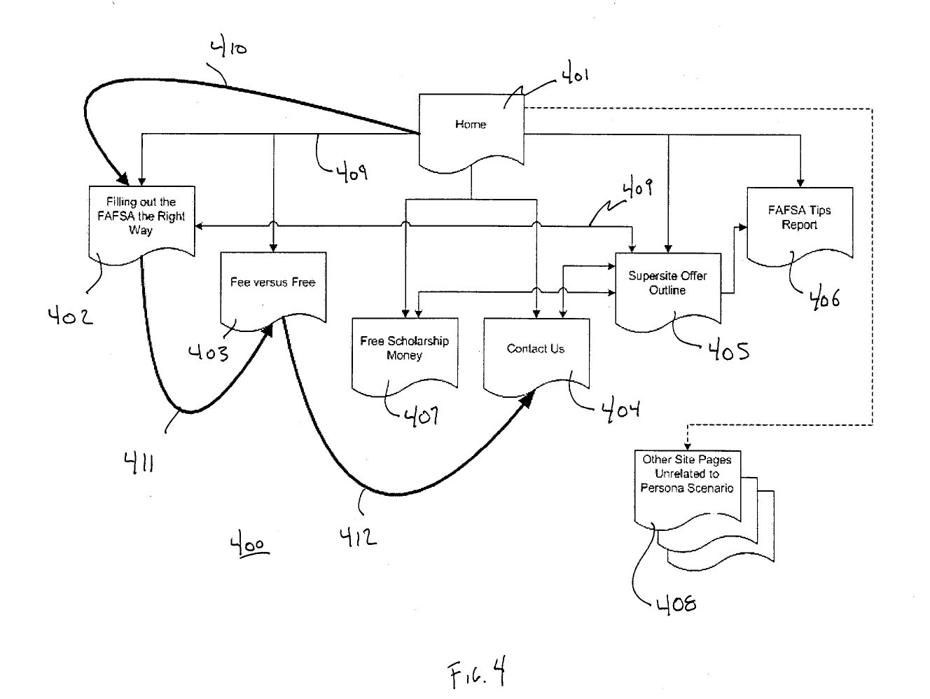

Referring now to FIG. 4, presented is a simplified diagram of an e-business web site 400 designed according to the present invention and using the personae determination as illustrated in the flow chats of FIGS. 2 and 3. Web site 400 includes a home page 401 and several secondary pages 402-408. Web pages 401-408 are connected by lines 409 representing possible transitions, also known as “click-throughs,” between an among the pages. For clarity, some but not all possible transitions 409 are shown.

Although e-business web site 400 is designed with several possible predetermined personae in mind, for clarity and illustration, only a single path is depicted. Specifically, starting at home page 401, and based on the information and presentation of information included in home page 401, an exemplary prospective customer is persuaded to take transition 410 to web page 402. From there, based on the information and presentation of information included in page 402, the prospective customer is persuaded to take transition 411 to web page 403. Finally, from there, based on the information and presentation of information included in page 403, the prospective customer is persuaded to take transition 412 to web page 404.

It should be noted that the path defined by web pages and transitions, 401-404 and 410-412 is traversed by a single prospective customer corresponding to a single predetermined personae. A different prospective customer, corresponding to a different, or perhaps even the same, personae, may take a different path through web site 400. However, it is expected that prospective customers corresponding to the same persona will take paths that are identical or substantially identical. In addition, different customers corresponding to different personae may in fact follow similar or intersecting paths. For example, in the web site illustrated in FIG. 4, it is expected or at least desired that all prospective customers, corresponding to all predetermined personae, will eventually be persuaded to land on page 404, “Contact Us.”

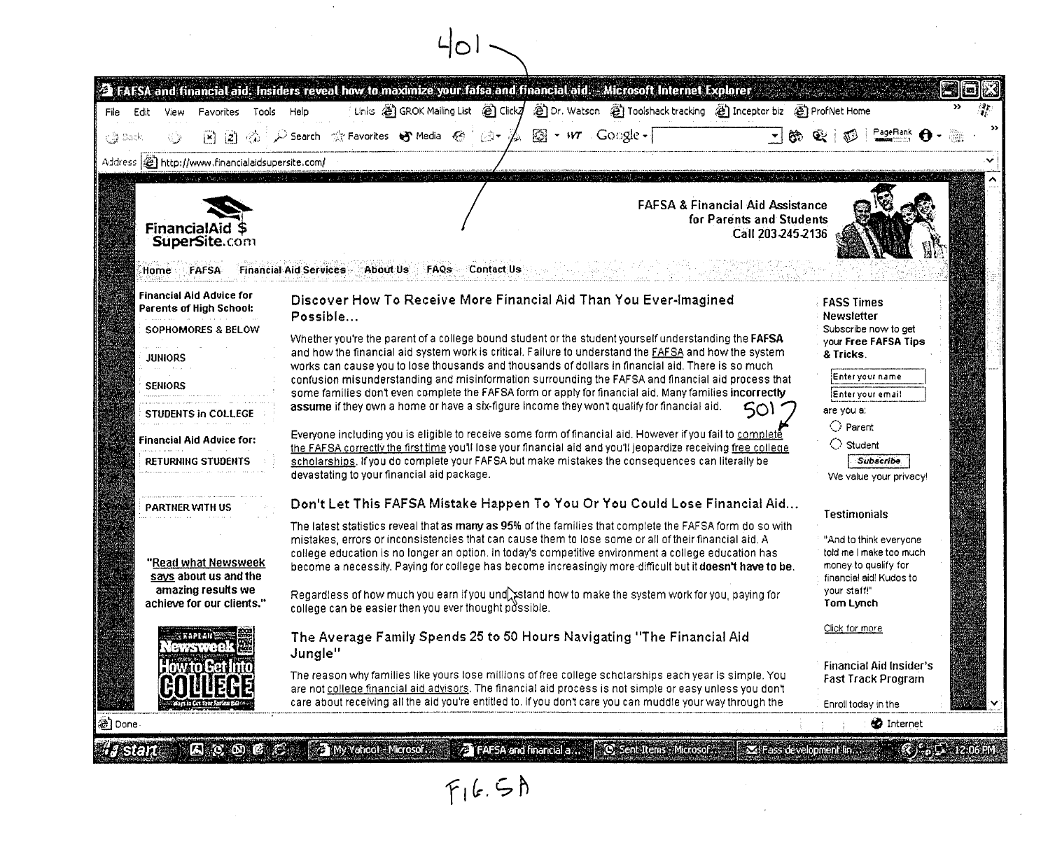

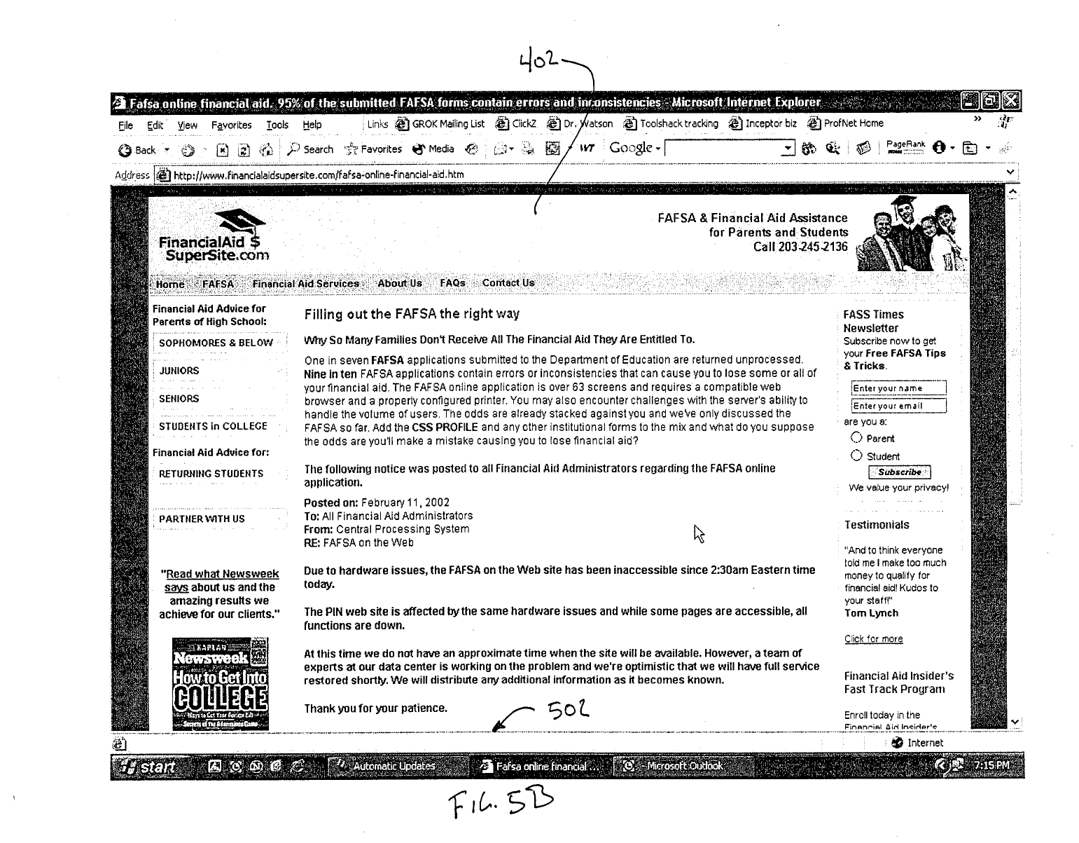

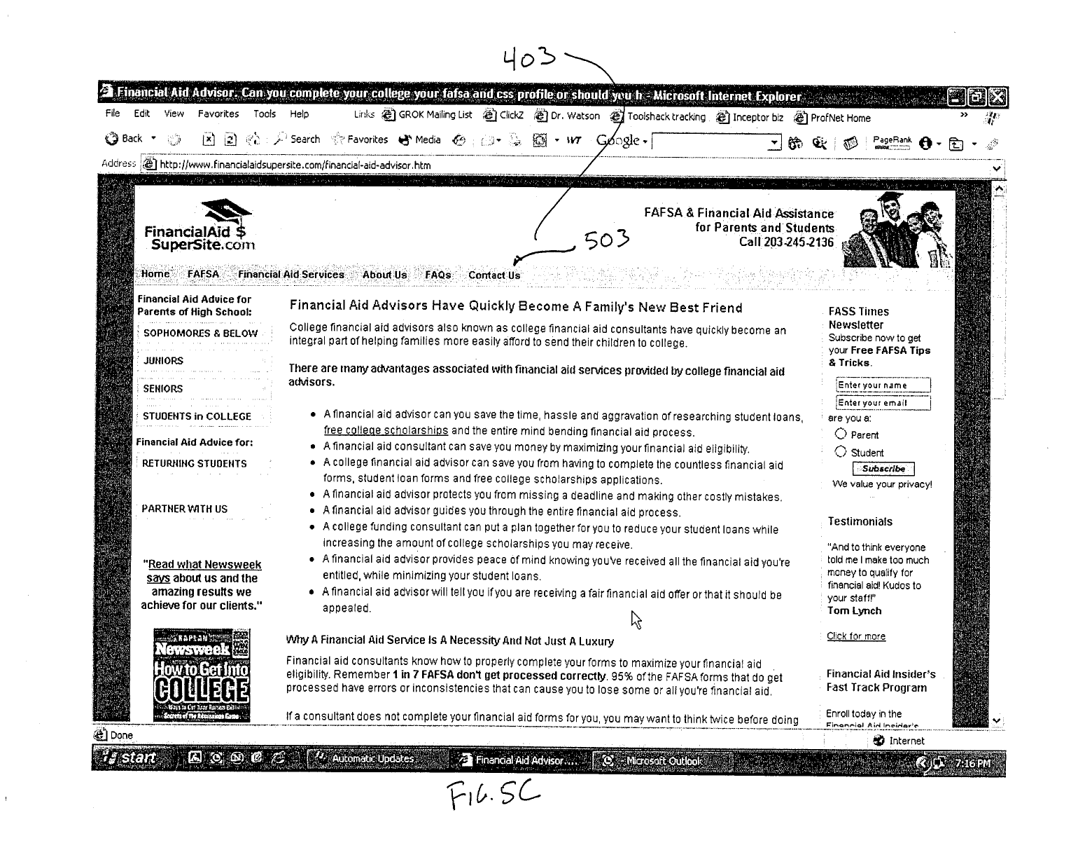

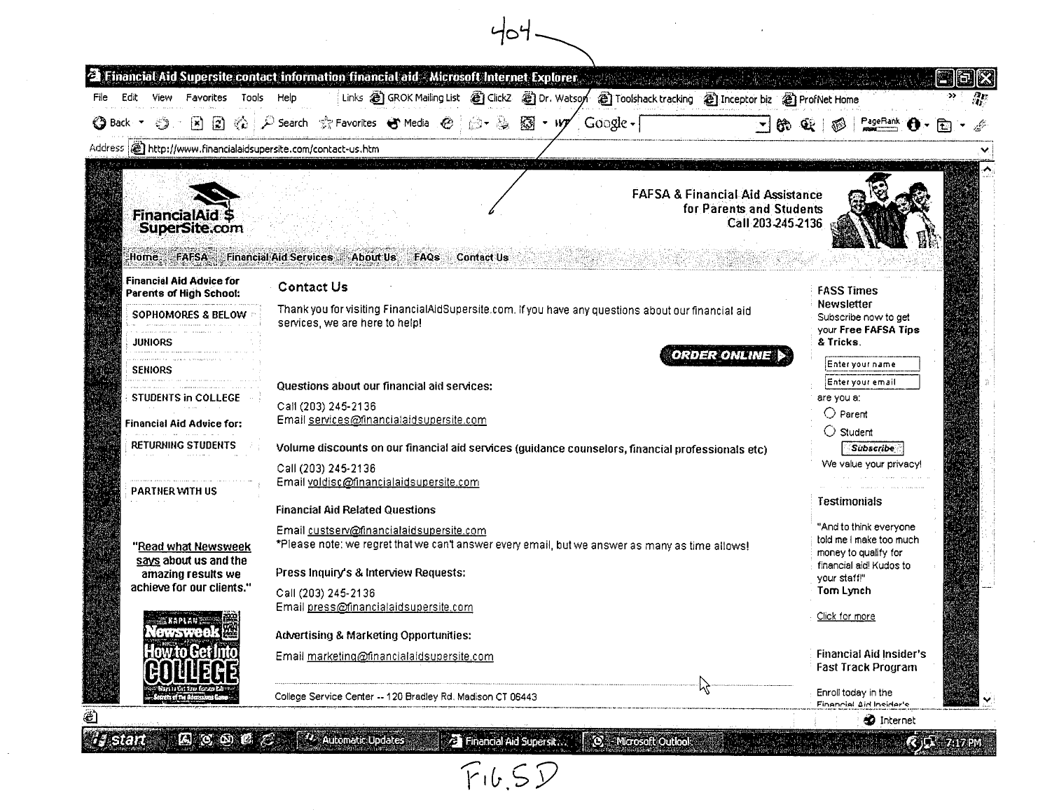

Referring now to FIGS. 5A-5D, illustrated are screen shots of completed web pages corresponding, respectively, to web pages 401-404 of e-business web site 400 of FIG. 4. Each of web pages 401-404 have been designed using the process illustrated in the flow charts of FIGS. 2 and 3 as described in detail above. In accordance with the identification of predetermined personae expected to visit site 400, individual pages 401-404 are designed to present information in a manner that persuades prospective customers corresponding to the predetermined personae to stay interested in the site and to advance to other pages within the site.

For example, the information and presentation of information on page 401 has been designed with respect to a plurality of predetermined personae, and one of those personae is intended to be persuaded to activate link 501 in FIG. 5A which leads the visitor to page 402 through transition 410. Further, the information and presentation of information on page 402 has been designed with respect to predetermined personae, and one of those personae is intended to be persuaded to activate link, link 502 in FIG. 5B (actually located lower in the window and not visible in FIG. 5B) which leads the visitor to page 403 through transition 411. Finally, the information and presentation of information on page 403 has been designed with respect to predetermined personae which are intended to be persuaded to activate link 503 in FIG. 5C which leads the visitor to page 404 through transition 412.

The terms a or an, as used herein, are defined as one or more than one. The term plurality, as used herein, is defined as two or more than two. The terms including and/or having, as used herein, are defined as comprising (i.e., open language). The term program or software, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents.

What is claimed is:

1. A computer system for providing electronic business services, comprising:
a network;
at least one customer computer associated with at least one customer and connected to the network, the at least one customer computer including a web browser for accessing and communicating over the network; and
at least one merchant computer associated with at least one merchant and connected to the network, the merchant computer being accessible by the customer computer via the network, the merchant computer including a plurality of web pages constructed and configured according to predetermined personae of customers anticipated to access the at least one merchant computer.

2. The system of claim 1, wherein definition of the customer personae includes demographic information.

3. The system of claim 1, wherein definition of the customer personae includes psychographic information.

4. The system of claim 1, wherein definition of the customer personae includes topographic information.

5. The system of claim 1, the at least one merchant computer including storage for storing the plurality of web pages.

6. The system of claim 1, the at least one merchant computer further comprising:
a customer database for storing information regarding customers who access the at least one merchant computer.

7. The system of claim 1, the at least one merchant computer further comprising:
an order database for storing information regarding orders placed by customers who access the at least one merchant computer.

8. The system of claim 1, the at least one merchant computer further comprising:
an inventory database for storing information regarding goods or services available to customers who access the at least one merchant computer.

9. A method for electronic business, comprising:
defining a plurality of personae of customers anticipated to access a web site;
creating a plurality of web pages as a function of the defined personae
creating a plurality of paths connecting the web pages, as a function of the defined personae;
storing the plurality of web pages and data regarding the plurality of paths; and
providing access to the plurality of web pages to prospective customers according to the plurality of paths and as a function of a persona of each prospective customer.

10. The method of claim 9, further comprising:
guiding each prospective customer though the plurality of web pages according to a respective path corresponding to a persona of the prospective customer.

11. A program storage device, readable by a machine and tangibly embodying a representation of a program of instructions adapted to be executed by said machine to perform the method of claim 9.

12. A method for designing an electronic business system, comprising:
defining a plurality of personae corresponding to customers anticipated to access the system;
creating a plurality of web pages as a function of the defined plurality of personae, each web page having information in a form to persuade prospective customers into purchasing a product or service;
linking the plurality of web pages as a function of the defined plurality of personae; and
providing access to the plurality of web pages by prospective customers.

13. The method of claim 12, the linking step further comprising:
defining a plurality of paths through the plurality of web pages as a function of the defined plurality of personae.

14. The method of claim 13, the step of providing access further comprising:
transferring a prospective customer from one web page to another within said plurality of web pages according to a respective path corresponding to a persona of the prospective customer.

15. A program storage device, readable by a machine and tangibly embodying a representation of a program of instructions adapted to be executed by said machine to perform the method of claim 12.
